(19) United States
(12) Patent Application Publication
(10) Pub. No.: US 2012/0175381 A1
(43) Pub. Date: Jul. 12, 2012

(54) Gumball machine

(76) Inventor: Hoi Wai Fu, Hong Kong (HK)

(21) Appl. No.: 12/930,675

(22) Filed: Jan. 12, 2011

(51) Int. Cl. B65D 83/04; B23P 11/00; B65G 59/00

(52) U.S. Cl. 221/92; 221/199; 29/428

(57) ABSTRACT

A gumball machine includes a gumball container having a housing that contains a plurality of gumballs, and a dispensing section that has a knob for controlling the dispensing of a gumball. The gumball machine also includes a base having a bottom portion that is seated on a surface, the base having a body with an opening through which a gumball is dispensed. A plurality of novelty modules are removably connected to each other, with each module having a different novelty feature. The plurality of novelty modules includes an upper module that is removably connected to the dispensing section, and a lower module that is removably connected to the base.

### BACKGROUND OF THE INVENTION

1. Field of the Invention

The present invention relates to gumball machines, and in particular, to a gumball machine having different novelty features that can be assembled into different configurations by a user.

2. Description of the Prior Art

Gumball machines have been popular novelty items for a long time. Children and adults alike have enjoyed dispensing a gumball from a spherical transparent container. Some gumball machines have even been provided with tracks along which the gumball can travel while being dispensed.

### SUMMARY OF THE DISCLOSURE

It is an object of the present invention to provide a gumball machine that provides additional fun and novelty for the user.

In order to accomplish the objects of the present invention, the gumball machine according to the present invention includes a gumball container having a housing that contains a plurality of gumballs, and a dispensing section that has a knob for controlling the dispensing of a gumball. The gumball machine also includes a base having a bottom portion that is seated on a surface, the base having a body with an opening through which a gumball is dispensed. A plurality of novelty modules are removably connected to each other, with each module having a different novelty feature. The plurality of novelty modules includes an upper module that is removably connected to the dispensing section, and a lower module that is removably connected to the base.

### BRIEF DESCRIPTION OF THE DRAWINGS

FIG. 1 is a front plan view of a gumball machine according to the present invention.

FIG. 2 is an expanded front plan view of the gumball container of the gumball machine of FIG. 1.

FIG. 3 is an expanded front plan view of the base of the gumball machine of FIG. 1.

FIG. 4A illustrates a different novelty module that can be used with the gumball machine of FIG. 1.

FIG. 4B illustrates how a gumball travels along the novelty item in the module of FIG. 4A.

FIG. 5A illustrates another novelty module that can be used with the gumball machine of FIG. 1.

FIG. 5B illustrates how a gumball travels along the novelty item in the module of FIG. 5A.

FIG. 6A illustrates a further different novelty module that can be used with the gumball machine of FIG. 1.

FIG. 6B illustrates how a gumball travels along the novelty item in the module of FIG. 6A.

FIG. 7A illustrates another novelty module that can be used with the gumball machine of FIG. 1.

FIG. 7B illustrates how a gumball travels along the novelty item in the module of FIG. 7A.

FIG. 8A illustrates yet another novelty module that can be used with the gumball machine of FIG. 1.

FIG. 8B illustrates how a gumball travels along the novelty item in the module of FIG. 8A.

FIG. 9 illustrates yet a further novelty module that can be used with the gumball machine of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

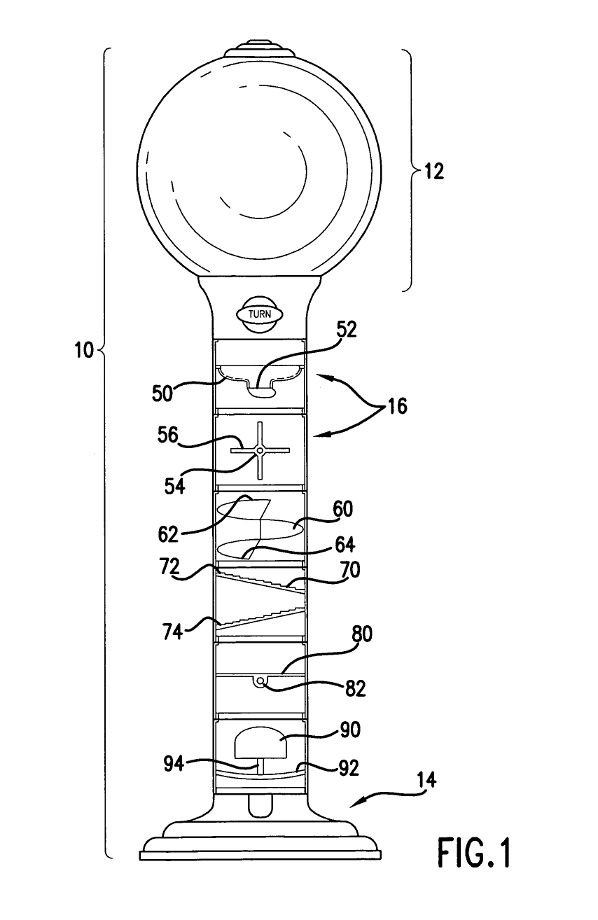

Referring to FIGS. 1-3, the gumball machine 10 of the present invention has a gumball container 12, a base 14 and a plurality of novelty modules 16 positioned between the gumball container 12 and the base 14. Each of the gumball container 12, the base 14 and the modules 16 can be removably coupled to each other in a manner such that the gumball container 12 is always at the top, the base 14 is always at the bottom, and the modules 16 can be positioned in any order or configuration between the gumball container 12 and the base 14.

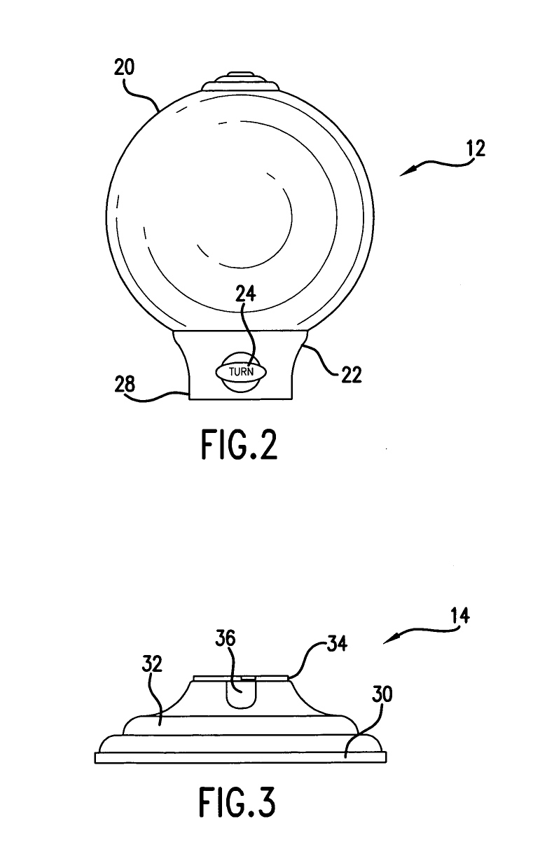

Referring to FIGS. 1 and 2, the gumball container 12 has a spherical housing 20 that can be made of a transparent material, such as plastic. Even though the housing 20 is shown as being spherical in configuration, it can be provided in any desired shape or size, and can even be configured as an object (e.g., an animal, a cup, etc.). A dispensing section 22 is secured to the bottom of the housing 20. The dispensing section 22 can be constructed like any conventional dispensing section 22 on a conventional gumball machine, and includes a knob 24 that is mechanically connected to a conventional rotating dispenser (not shown) that allows the gumball to pass in a circular slide and drop to the bottom of the dispensing section 22, which has a flanged opening 28 having internal threads that are adapted to removably engage an externally-threaded cylindrical extension from a module 16 or the base 14.

The base 14 has an enlarged bottom section 30 that is adapted to be seated on the ground or a flat surface. The base 14 has a body 32 extending from the bottom section 30, and the body 32 can be provided in any desired configuration, such as in the curved stepped configuration shown in FIGS. 1 and 3. An externally-threaded cylindrical extension 34 extends upwardly from the top of the body 32. An opening 36 is provided in the body 32 to allow a gumball to exit the base 14.

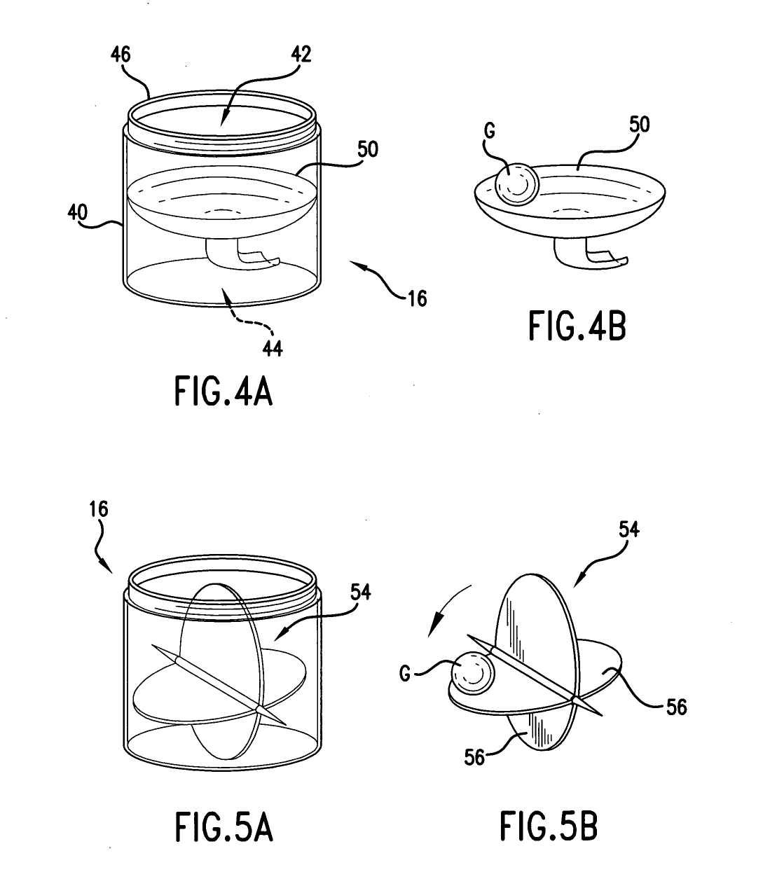

Each module 16 is provided with a cylindrical wall 40 with an opened upper end 42 and an opened lower end 44. The lower end 42 of each module 16 has a flanged opening having internal threads that are adapted to removably engage an externally-threaded cylindrical extension from another module 16 or the base 14. An externally-threaded cylindrical extension 46 extends upwardly from the upper end 42 of each module 16. See FIG. 4A.

A different novelty item is secured inside each separate module 16. For example, FIGS. 1 and 4A show a module 16 having a hemispherical bowl-shaped plate 50 secured to the cylindrical wall 40. The plate 50 has an opening 52 at the center of its bottom. The plate 50 is shaped so that a gumball G entering the module 16 from the top will contact the plate 50, and the hemispherical shape of the plate 50 will cause the gumball G to travel downwardly in a spiral manner until it reaches the opening 52 where it can then fall (via the force of gravity) to the next module 16 or into the base 14. See FIG. 4B.

FIGS. 1 and 5A show a module 16 having a paddle 54 secured to the cylindrical wall 40. The paddle 54 has a four fins 56 extending from its center to provide a perpetual motion effect. The paddle 54 is configured so that a gumball G entering the module 16 from the top will contact one of the fins 56, causing the paddle 54 to rotate which will allow the gumball to drop downwardly (via the force of gravity) to the next module 16 or into the base 14. See FIG. 5B.

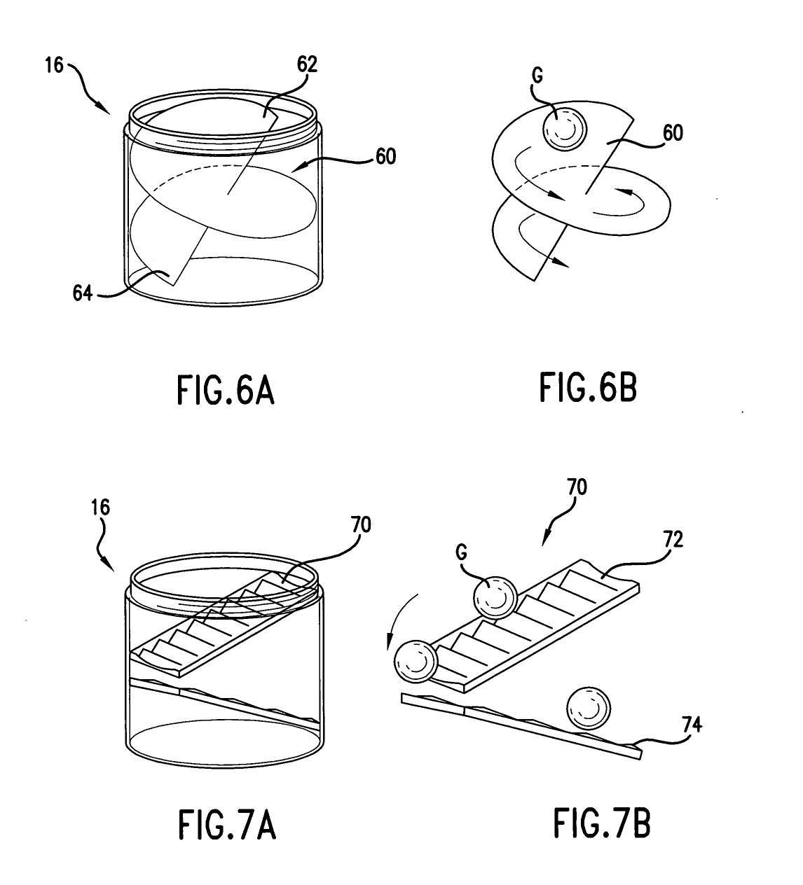

FIGS. 1 and 6A show a module 16 having a three-step spiral passageway 60 secured to the cylindrical wall 40. The passageway 60 has an upper end 62 and a lower end 64. The passageway 60 is configured so that a gumball G entering the module 16 from the top will enter the passageway 60 at the upper end 62, and travel downwardly in a spiral path until it reaches the lower end 64 where it can then fall (via the force of gravity) to the next module 16 or into the base 14. See FIG. 6B.

FIGS. 1 and 7A show a module 16 having a staircase-like passageway 70 secured to the cylindrical wall 40. The passageway 70 has a plurality of separate staggered steps, like a staircase. The passageway 70 can be divided into a plurality of stages (e.g., FIGS. 7A and 7B show a passageway 70 with two stages). The passageway 70 also has an upper end 72 at the upper stage, and a lower end 74 at a lower stage. The passageway 70 is configured so that a gumball G entering the module 16 from the top will enter the passageway 70 at the upper end 72, and travel downwardly in a spiral path until it reaches the lower end 74 where it can then fall (via the force of gravity) to the next module 16 or into the base 14. See FIG. 7B.

Referring to FIG. 1, there is another module 16 having a see-saw platform 80 secured to the cylindrical wall 40. The platform 80 is pivoted about a fulcrum 82 provided at its center. The platform 80 is configured so that a gumball entering the module 16 from the top will contact one of the sides of the platform 80, causing the platform 80 to pivot about the fulcrum 82 which will allow the gumball to drop downwardly (via the force of gravity) to the next module 16 or into the base 14.

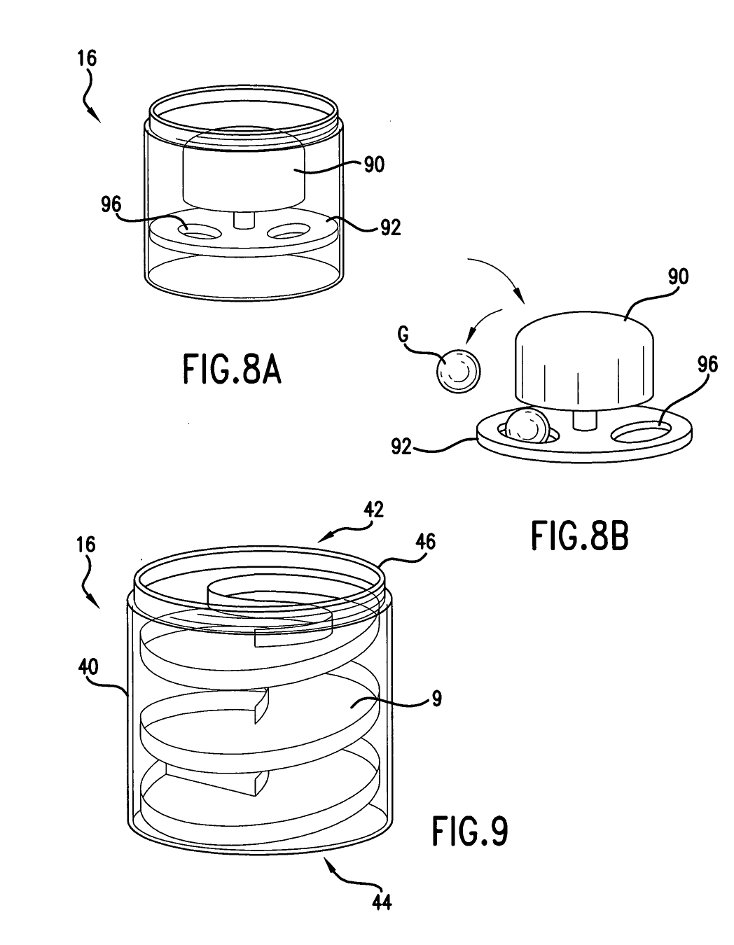

FIGS. 1 and 8A shows a module 16 having a bell member 90 secured to the cylindrical wall 40 via a plate 92 and a shaft 94. The plate 92 has a plurality of openings 96. The bell member 90 is configured so that a gumball G entering the module 16 from the top will strike the bell member 90, emitting a ringing sound, and then drop onto the plate 92 and fall (via the force of gravity) via an opening 96 to the next module 16 or into the base 14. See FIG. 8B.

FIG. 1 illustrates all of the above-described modules 16 assembled so that these modules 16 are between the gumball container 12 and the base 14. Because of the simple engaging connection between the flanged opening having internal threads (at the bottom of the modules 16 and the dispensing section 22) and the externally-threaded cylindrical extensions (at the top of the modules 16 and the base 14), it easy and convenient to assemble a complete gumball machine having any number (or sequence) of the modules 16 between the gumball container 12 and the base 14. As an alternative, a friction fit connection can be provided between the flanged openings (at the bottom of the modules 16 and the dispensing section 22) and the cylindrical extensions (at the top of the modules 16 and the base 14) instead of the threaded connection.

Therefore, the user creates a gumball machine using any or all of the modules 16, and arranging these modules 16 in the desired arrangement and sequence. The user can dispense a gumball by turning the knob 24, causing a gumball from the gumball container 12 to travel through the specially-designed pathway created by the user's arrangement of the modules 16. If configured according to the arrangement shown in FIG. 1, the gumball will spiral through the bowl-shaped plate 50, then cause the paddle 54 to rotate, then travel down the spiral passageway 60, down the staircase passageway 70, see-saw down the see-saw platform 80, and strike the bell member 90 before exiting the base 14 at the opening 36. As a result, the gumball machine of the present invention increases the play variety and novelty afforded to the user as the user can select any number of modules 16 and in any desired sequence.

In addition, even though the present invention illustrates certain novelty items, these examples are not limiting. Other novelty items can be provided, including other stepped configurations, helical and tubular passageways, etc. As a non-limiting example, FIG. 9 illustrates another module 16 having a spiral passageway 98 secured to the cylindrical wall 40. The passageway 98 has an upper end and a lower end, and is configured so that a gumball entering the module 16 from the top will enter the passageway 98 at the upper end, and travel downwardly in a spiral path until it reaches the lower end where it can then fall (via the force of gravity) to the next module 16 or into the base 14.

While the description above refers to particular embodiments of the present invention, it will be understood that many modifications may be made without departing from the spirit thereof. The accompanying claims are intended to cover such modifications as would fall within the true scope and spirit of the present invention.

1-10. (canceled)

11. A gumball machine assembly, comprising:
a gumball container having a housing that contains a plurality of gumballs, and a dispensing section that has a knob for controlling the dispensing of a gumball;
a base having a bottom portion that is seated on a surface, the base having a body with an opening through which a gumball is dispensed;
a plurality of novelty modules removably connected to each other, each module having a housing, and a novelty feature secured inside the housing of the module, and wherein each novelty feature is different from all the other novelty features; and
wherein the plurality of novelty modules including an upper module that is removably connected to the dispensing section, and a lower module that is removably connected to the base, such that when the plurality of novelty modules are stacked together, a gumball travel path is defined from the dispensing section through the novelty features in the stacked housings of the novelty modules and then to the base.

12. The assembly of claim 11, wherein the plurality of novelty modules comprises at least three separate modules.

13. The assembly of claim 12, wherein the plurality of novelty modules includes a novelty module having a bowl-shaped hemispherical plate with an opening at its bottom, with the bowl-shaped hemispherical plate secured inside the housing of the novelty module.

14. The assembly of claim 12, wherein the plurality of novelty modules includes a novelty module having a rotating paddle having a plurality of fins, with the paddle secured inside the housing of the novelty module.

15. The assembly of claim 12, wherein the plurality of novelty modules includes a novelty module having a spiral passageway secured inside the housing of the novelty module.

16. The assembly of claim 12, wherein the plurality of novelty modules includes a novelty module having a staircase passageway having a plurality of stages, the staircase passageway secured inside the housing of the novelty module.

17. The assembly of claim 12, wherein the plurality of novelty modules includes a novelty module having a seesaw plate pivoting about a fulcrum, the seesaw plate and fulcrum secured inside the housing of the novelty module.

18. The assembly of claim 12, wherein the plurality of novelty modules includes a novelty module having a bell member secured inside the housing of the novelty module.

19. A method of creating different gumball machines, comprising the steps of:
providing a gumball container having a housing that contains a plurality of gumballs, and a dispensing section that has a knob for controlling the dispensing of a gumball;
providing a base having a bottom portion that is seated on a surface, the base having a body with an opening through which a gumball is dispensed;
providing a plurality of novelty modules, each having a different novelty feature;
connecting a first of the plurality of novelty modules to the dispensing section;
connecting a second of the plurality of novelty modules to the base;
connecting a third of the plurality of novelty modules between the first and second novelty modules;
removing all of the novelty modules from the base and the dispensing section; and
connecting the first, second and third novelty modules to the dispensing section and the base, and the between the dispensing section and the base, into a different sequence of arrangement.
